(19) United States
(12) Patent Application Publication
(10) Pub. No.: US 2013/0100704 A1
(43) Pub. Date: Apr. 25, 2013

(54) LIGHT GUIDE WITH A PRINTED FILM

(71) Applicants: Martin A. KYKTA, Austin, TX (US); Robert PETCAVICH, The Woodlands, TX (US); Steven A. MILLER, Spring, TX (US); Danliang JIN, Bothell, WA (US)

(72) Inventors: Martin A. KYKTA, Austin, TX (US); Robert PETCAVICH, The Woodlands, TX (US); Steven A. MILLER, Spring, TX (US); Danliang JIN, Bothell, WA (US)

(73) Assignee: UNIPIXEL DISPLAYS, INC., The Woodlands, TX (US)

(21) Appl. No.: 13/486,334

(22) Filed: Jun. 1, 2012

Related U.S. Application Data
(60) Provisional application No. 61/551,243, filed on Oct. 25, 2011.
(60) Provisional application No. 61/593,280, filed on Jan. 31, 2012.

(51) Int. Cl. F21V 8/00; B32B 38/14; B05D 5/06

(52) U.S. Cl. 362/627; 427/163.2; 156/278; 156/273.3

(57) ABSTRACT

A method for making a light guide includes transferring ink onto a master tool having a three-dimensional feature pattern formed thereon and then transferring ink from the master tool to a transparent light guide. The method also includes curing the ink on the light guide. Alternatively, the ink may be printed onto a substrate (e.g., a film) and then laminated to the light guide.

### CROSS-REFERENCE TO RELATED APPLICATION

The present application claims priority to U.S. Provisional Pat. App. Nos. 61/551,243, filed Oct. 25, 2011 (“Apparatus and Method for Making a Light Guide Using a Laminated Film”) and 61/593,280, filed on Jan. 31, 2012 (“Apparatus and Method for Making a Light Guide Using a Laminated Film”), both of which are hereby incorporated by reference.

### BACKGROUND

Backlights are used in displays such as liquid crystal displays (LCDs), but may also be used for general lighting. Some backlight systems use a light directly behind the display. Other types of lighting systems use light sources (e.g., light emitting diodes) that inject light from the side of the display into a light guide and are called “edge-lit backlights.” The light guide is a thin transparent structure that may be positioned directly behind the display. Light confined within the guide (and propagating within the guide) is scattered by small structures on the surface of the light guide. These small structures function to cause light rays propagating internal to the light guide to be extracted and directed generally normal to the surface of the light guide and thus through the display itself. Because the light sources are off to the side and are typically small, displays that employ edge-lit lighting system may be considerably thinner than displays with conventional back-lights.

### SUMMARY

Described herein are various techniques for making a light guide for a backlight. The techniques include, for example, printing scattering light extraction features on a plastic polymer substrate (e.g., a film) by a printing process, and then using an optical adhesive to laminate the substrate to a solid piece of plastic to make the light guide. The optical adhesive may closely match the index of refraction of the light guide and printed dot substrate indexes. The scattering particles printed on the substrate may take on various shapes and patterns. In some embodiments, the features are printed directly on the light guide and not on a substrate to be laminated to the light guide. The printing process uses a master tool to transfer ink to the light guide or substrate. The light extraction features may be uniformly-sized but non-uniformly spaced, non-uniformly sized but uniformly spaced, or non-uniformly spaced and non-uniformly sized.

### BRIEF DESCRIPTION OF THE DRAWINGS

For a detailed description of exemplary embodiments of the invention, reference will now be made to the accompanying drawings in which:

FIG. 1 shows a method of fabricating a master tool in accordance with various embodiments;

FIGS. 2A-2C show various embodiments of master tools;

FIG. 3 illustrates the process for printing ink on a substrate using the master tools in accordance with various embodiments;

FIG. 4 shows a top view of a light guide with evenly spaced, but non-uniformly sized light extraction features in accordance with various embodiments;

FIGS. 5A and 5B show various examples of light guides with non-uniformly spaced but uniformly sized light extraction features;

FIGS. 6A and 6B show additional examples of side views of light guides;

FIGS. 7A and 7B show further examples of side views of light guides;

FIGS. 8A and 8B show additional examples of light guides in which a substrate is printed and adhered to a light guide and in which the light extraction features are printed directly on the light guide;

FIGS. 9A and 9B illustrates light guide examples in which the light extraction features are not uniformly spaced;

FIGS. 10A and 10B depict how light rays are extracted out by the light extraction features of the light guide.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Conventional light guides typically are injection molded or laser scribed. Injection molding and laser scribing are slow and require large, costly manufacturing machines. In accordance with the preferred embodiments, a process for making a light guide based on a printing process is described. The disclosed embodiments advantageously provide a cost effective, efficient, uniform, compact, long-lived method of producing a light guide for backlights for LCDs or for general purpose lighting. Further, the printing is performed by printing the optical extraction features in a roll-to-roll process, thereby allowing for easier inspection for errors and non-uniformities before laminating the film to a plastic waveguide.

### Overview

The preferred embodiments of the invention are directed to a printing technique for printing predetermined patterns for a light guide. The printed patterns have any desired geometry and form the light extraction features for the light guide. The process generally involves three operations in some embodiments. In a first operation, a master tool is made having the predetermined patterned formed thereon. In a second operation, the master tool is then used in the printing process to transfer ink in the predetermined pattern onto a film to form a printed substrate. In a third operation, the printed substrate is adhered to a blank optically transparent structure to form the light guide.

In other embodiments, after making the master tool, the master tool is used to print ink onto a substrate (e.g., acrylate) that itself is the light guide. In other words, ink is not printed on a film that is then adhered to a blank optically transparent structure; instead, ink is printed directly on a blank optically transparent structure.

### Master Tool

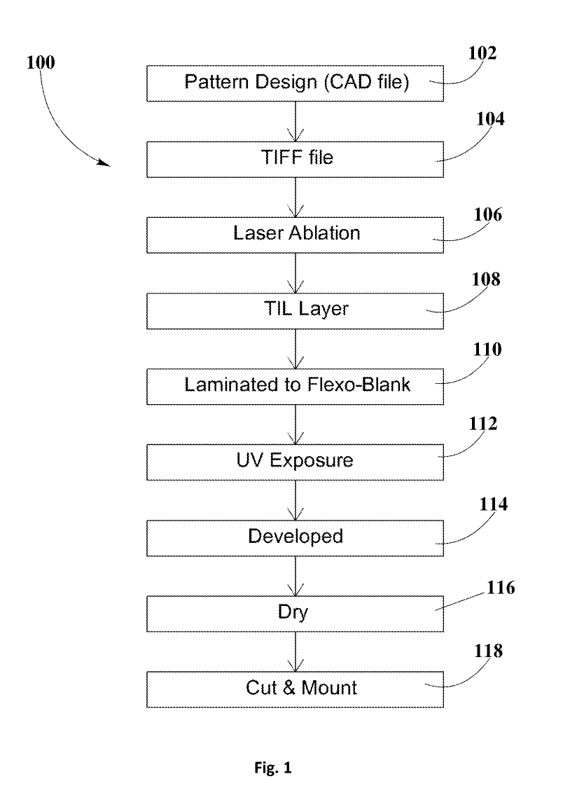

FIG. 1 shows a preferred embodiment of a process 100 to create the master tool which is subsequently used in the printing process. The operations depicted may be performed in the order shown or in a different order. At 102, a pattern previously is generated using, for example, computer-aided design (CAD) software that is subsequently converted (104) into a tagged image format (TIF) file or other image file. Then, the image may be loaded onto a thermal patterning system. In the thermal patterning system at 106 the pattern is engraved, for example using laser ablation, of a black resist material on top of a clear film to make a pattern. Next, a blank elastomeric laminated photoresist is exposed to a ionizing radiation (e.g., ultraviolet) through the pattern. This pattern is thus “recorded” in the laminated photoresist. After being recorded, it is developed, dried and cut. This “flexo-master” (laminated elastomeric photoresist, carrying the pattern on one side) is then adhered to a printing roller thereby forming the printing master tool. This disclosure is not limited to the printing process just described, which uses a flexographic; for example, the ink could also be printed using any other roll-to-roll printing process.

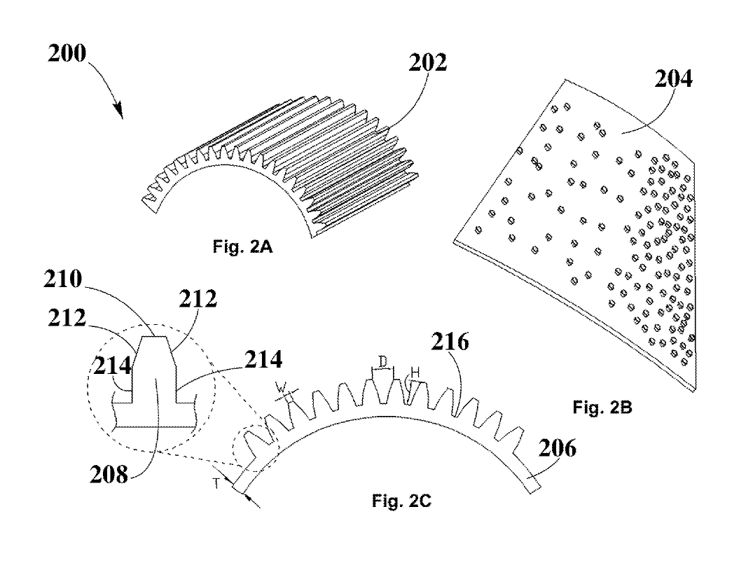

FIGS. 2A-2C show examples of flexo-masters in accordance with various embodiments. In FIGS. 2A and 2B, isometric views of a portion of two illustrative flexo-masters 202 and 204 are shown. The flexo-master 202 comprises straight lines, whereas flexo-master 204 comprises a dot pattern. The straight line pattern in FIG. 2A comprises a plurality of ridges, better shown in FIG. 2C. Each ridge 208 comprises a top surface 210, angled side walls 212 vertical side walls 214 as shown. The width W of each top surface 210 may be between 3 and 5 microns. The inter-ridge distance D (FIG. 2C) may be between 1 and 5 mm while the height H of each ridge may be between 10 and 200 microns. The total thickness T of base material 216 may be between 1.14 and 2.84 mm. The flexo-tools can be a flat sheet or cylindrical in nature. This disclosure is not limited to the printing process just described, which uses a flexographic; for example, the ink could also be printed using any other roll-to-roll printing process.

### Printing Process

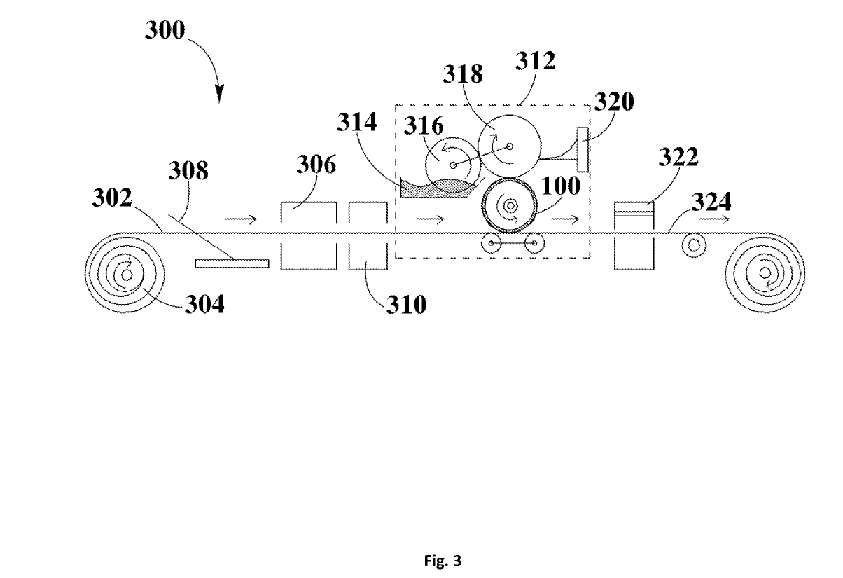

FIG. 3 illustrates an embodiment of a printing process 300 for printing a feature pattern on a substrate 300. Ink is used in the printing process 300. The ink provides the physical and optical properties required by light guide. Such properties include scattering and refractive index. The ink should be able to transfer accurately from a printing tool on a roll to the target substrate with consistent volume and duplication of the shape and features from the printing tool. The ink also should sufficiently adhere to the substrate and be curable through ionizing radiation exposure, heat or volatile evaporation at high printing speed (e.g., 750 feet per minute). Furthermore, the printing structure also should be robust for the following device fabrication. In order to realize high printing speed and curable features simultaneously, ionizing radiation-curable inks may be selected. In addition, in order to have high scattering property, a ionizing radiation-curable ink doped with titanium oxide particles may be employed although other types of high refractive index particles may be used. One consideration is that the ink thickness and concentration is sufficient to create light scattering with some transmission. However, this ink may not print clearly and uniformly using a printing tool with the target design and features. Therefore, the ink may be further modified to achieve satisfactory printing properties and to maintain the desired optical properties. Certain modifications that may be used are SR295 and SR610 from Sartomer or Doublecure 184 and Doublecure BDK from Double Bond Chemical.

When the ink and the master tool are ready as explained above, a roll-to-roll printing process such as that shown in FIG. 3 is performed. Such printing process involves various operations. First, a substrate 302 that may comprise poly(methyl methacrylate (PMMA), polyethylene terephthalate (PET) on unwind roll 304 is transferred from unwind roll 304 to a first cleaning system 306 via any known roll-to-roll handling method, whose alignment may be controlled with an alignment mechanism 308. The first cleaning system 306 may then be used to remove any impurities from the substrate 302. The substrate 302 passes through a second cleaning system 310.

At 312, a pattern (e.g., a dot pattern) is printed on one side of substrate 302 in a process that may include the following operations. First, a portion of the ink, which is contained in ink pan 314, is transferred to anilox roll 318 by a transfer roll 316. Anilox roll 318 may comprise a steel or aluminum core coated by an industrial ceramic whose surface contains millions of very fine dimples, known as cells. Depending on the design of printing process 312, anilox roll 318 may be either semi-submersed in ink pan 314 or comes into contact with a metering roll. The rolls 316 and 318 may be in contact with each other as they turn thereby causing the ink from transfer roll 316 to be imparted onto anilox roll 318. A doctor blade 320 may be used to scrape excess ink from the surface of the anilox roll 318 leaving a precise measured amount of ink in the cells. The anilox roll 318 rotates to contact with the flexographic printing tool (master tool 322 formed as explained previously) which receives the ink from the cells. The master tool 322 rotates in contact with the substrate 302 and thus transfers ink to the substrate. The rotational speed of master tool 322 should match the speed of the substrate 302, which may vary between, for example, 20 feet per minute and 750 feet per minute. After the ink is transferred to the substrate by the master tool 322, the ink is cured at 324. Any suitable curing technique can be employed such as application of ionizing radiation, heat, etc. A printed substrate is rolled on to a take-up roller 326.

In some embodiments, the lamination step in the process described above may not be needed. The substrate 302 may be replaced by a thicker polymer substrate than the standard thin substrate as previously described. The thicker polymer substrate may be an acrylate which can be optically clear and may have a thickness of about 0.5 to 1 mm. In some cases, the acrylate is flexible enough to roll up. The substrate itself functions as the light guide.

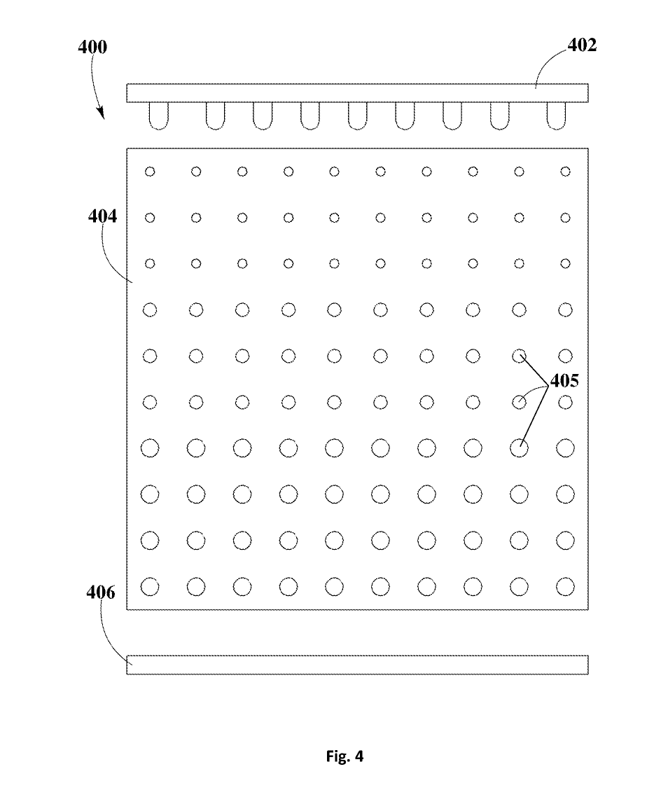

A portion of the printed substrate from the take-up roller 326 may be cut and laminated to a solid piece of plastic, or other material, to make a light guide. FIG. 4 shows a top view of the light guide with different sizes of features 405 uniformly distributed in a pattern 400. In FIG. 4, the features are linearly spaced in both x and y dimensions, where the features increase in size as the distance from an LED assembly 402 increases. In this particular example, the features are dots that are circular shaped, however the shape can be other than circular. Examples include square, rectangular or any other desired shape. The features 405 may be printed on either a thin substrate that is subsequently laminated to a solid piece of plastic, as explained above, or on a thicker polymer substrate of about 0.5 to 1 mm that may act as a waveguide, hence avoiding the lamination step (not shown). In FIG. 4, LED assembly 402 is used as a light source and is positioned at one edge of the light guide. LED assembly 402 comprises one or more LEDs and may be placed at the side where the dots in pattern 404 are smaller so the light coupled from LEDs can be scattered out with uniformity. Smaller features may be included near the LEDs and larger features may be included further the LEDs to maintain a constant amount of scattered light as the light becomes depleted from light guide with distance in order to achieve uniformity. LED assembly 402 may comprise a package that is rectangular with a dimension of about 0.750 by 2.75 mm. The example of FIG. 4 also includes end mirror 406 which is positioned opposite to LED assembly 402 in order to reflect back the light injected into the light guide by the LED assembly that is not scattered or reflected out, giving the reflected light another opportunity to exit the light guide. In some embodiments, two LED assemblies 402 may be positioned on opposing sides of the light guide. In that embodiment (LED assemblies on opposing sides of the light guide), the pattern 404 of features may comprise dots that are small at both sides where the LED assemblies are located and dot size increases toward the center of the light guide.

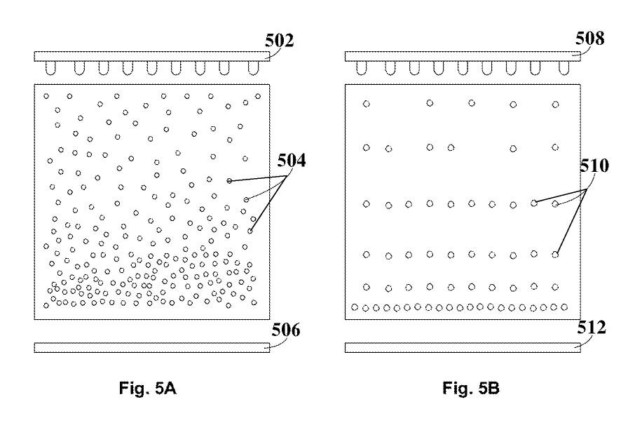

FIGS. 5A and 5B show a top view of two embodiments of a light guide. The features in each figure are of a common size, but are provided in non-uniformly distributed pattern. Fewer features may be included near the LEDs and more features further away from the LEDs in order to maintain a constant amount of scattered light as the light becomes depleted from light guide with distance in order to achieve uniformity. In FIG. 5A, the features 504 are somewhat randomly distributed. The distribution of features 504 is generally fairly sparse at the end near LED assembly 502 and become increasingly denser as the distance from LED assembly 502 increases (i.e., towards the end opposite LED assembly 502). In FIG. 5B, the features 510 also are of uniform size but non-linearly spaced in both x and y dimensions. The features 510 also become increasingly denser as the distance from LED assembly 508 increases.

In FIG. 5A, LED assembly 502 is used as a light source and is positioned at one edge of the light guide. The position of LED assembly 502 may be placed at the side where the features 504 are less dense so the light from LED assembly 502 can be scattered out across the light guide with uniformity. In FIG. 5B, LED assembly 508 also is used as a light source and is positioned at one edge of the light guide. The position of LED assembly 508 may be placed at the side where features 510 are less dense so the light from LED assembly 508 can be scattered out across the light guide with uniformity. In some embodiments, as explained above, two assemblies LEDs could be used on both sides of the light guides in the embodiments of FIGS. 5A and 5B. In this case, the feature patterns are such that the sparse dots start on the sides adjacent the LED assemblies and become increasingly denser towards the center. The embodiments of FIGS. 5A and 5B also include end mirrors 506 and 512, respectively, which are positioned opposite LED assemblies 502 and 508 in order to reflect back the light injected into the light guide that is not scattered or reflected out, giving the reflected light another opportunity to exit the light guide.

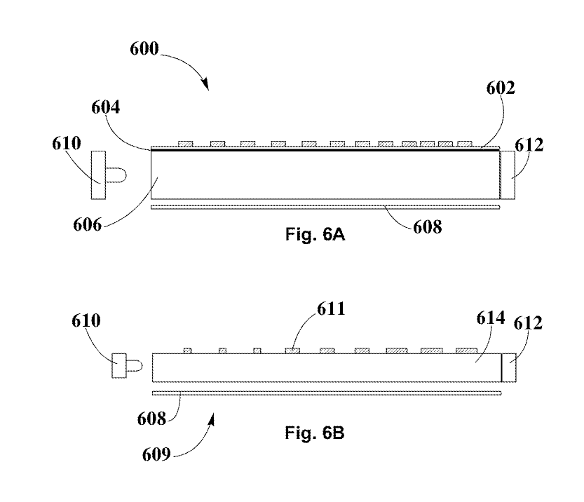

FIGS. 6A and 6B show a cross-sectional side view of light guides 600 and 609, respectively. The light guide 600 of Figure A includes an adhesive layer and light guide 609 of FIG. 6B does not include lamination.

In FIG. 6A, a printed substrate 602 (formed as explained previously) forms the top surface of the light guide 600 and the features printed on the surface may be dots that have the non-uniform (or the same) sizes and may be uniformly (or non-uniformly) distributed. An adhesive layer 604 laminates the printed substrate 602 to the light guide 606. A specular or diffuse reflector 608 forms the bottom layer of the light guide opposite the printed substrate. LED assembly 610 is shown at the left side of light guide 606 and an end mirror 612 is shown on the side opposite the LED assembly 612. The end mirror 612 reflects light back to into the light guide 606.

In the embodiment of FIG. 6B, features 611 (e.g., dots) are printed directly on a substrate 614 that itself acts as a light guide. As such, lamination is not required. A specular or diffuse reflector 608 forms the bottom layer. An end mirror 612 is shown at the right side, while an LED assembly 610 is shown at the left side of the light guide 614. The LED assembly 610 can be a rectangular package of about 0.750 by 2.75 mm. The LED 610, which has an emitting thickness of 0.5 mm, can be aligned to printed substrate 614 (waveguide) which has a thickness of 0.5 to 1 mm, as previously described The printed substrate 614 (light guide) may collect about 70% of the light emitted.

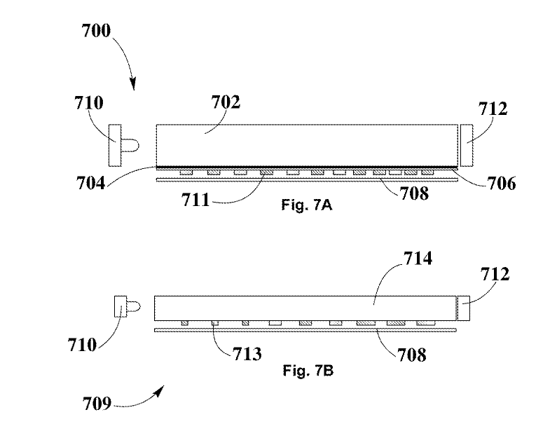

FIGS. 7A and 7B show cross-sectional side views of light guides 700 and 709 in accordance with other embodiments. Light guide 700 of FIG. 7A includes an adhesive layer while light guide 709 of FIG. 7B does not include lamination.

In FIG. 7A, a printed substrate 706 (printed as explained above) is adhered to the light guide 702 via an adhesive layer 704 that laminates the printed substrate 706 to the light guide 702. A specular or diffuse reflector 708 is shown on the same side of the light guide 702 as the printed substrate 706. Further, an LED assembly 710 is shown at left side of the light guide 702 and an end mirror 712 is shown at the right side of light guide 702. In the example of FIG. 7A, features 711 printed on printed substrate 706 may comprise dots that have the same size and are non-uniformly distributed across the light guide. The features 711 also face specular or diffuse reflector 708 as shown.

In FIG. 7B, features 713 are printed directly on the light guide 709 and thus lamination/adhesive is not required. A specular or diffuse reflector 708 forms the bottom layer. An end mirror 712 is provided at the right side and an LED assembly 710 at the left side. The LED assembly 710 may have an emitting thickness of 0.5 mm and may be aligned to printed substrate 714 (waveguide), which has a thickness of 0.5 to 1 mm, as previously described. The printed substrate 614 (waveguide) may collect about 70% of the light emitted.

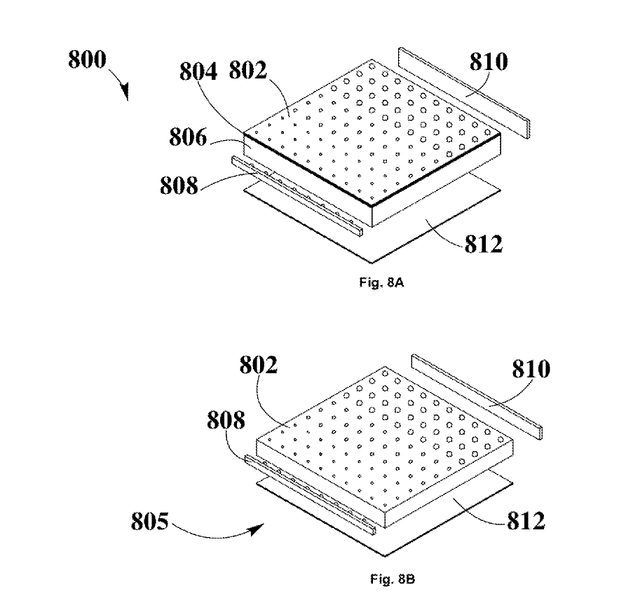

FIGS. 8A and 8B show an isometric view of light guide 800. The embodiment of FIG. 8A includes an adhesive layer, while the embodiment of FIG. 8B does not include lamination.

In FIG. 8A, a dot pattern 802, which has dots of a varying sizes, is printed uniformly on the substrate (e.g., a film), and an adhesive layer 804 (e.g., transparent glue) laminates the printed substrate to a light guide 806. The embodiment FIG. 8A also shows an LED assembly 808 as a light source, placed at one side of waveguide 806, specifically where the dots in the pattern are smaller. Opposite to the LED assembly 808 and at the rear end of waveguide 806, an end mirror 810 is located. Finally, a specular or diffuse reflector 812 forms the bottom layer.

In FIG. 8B a light guide 805 is having a dot pattern 802. The pattern 802 includes dots of different sizes that are printed uniformly on the substrate. In this embodiment, the same printed substrate itself acts as the light guide as noted above and thus no lamination is required. The printed substrate may have a thickness of 0.5 to 1 mm. Embodiment B also shows an LED assembly 808 as a light source, placed at one side of the printed substrate (waveguide), specifically where the dots in the pattern are smaller. Opposite to the LED assembly 808 and at the rear end of printed substrate (waveguide), an end mirror 810 is located. Finally, a specular or diffuse reflector 812 forms the bottom layer.

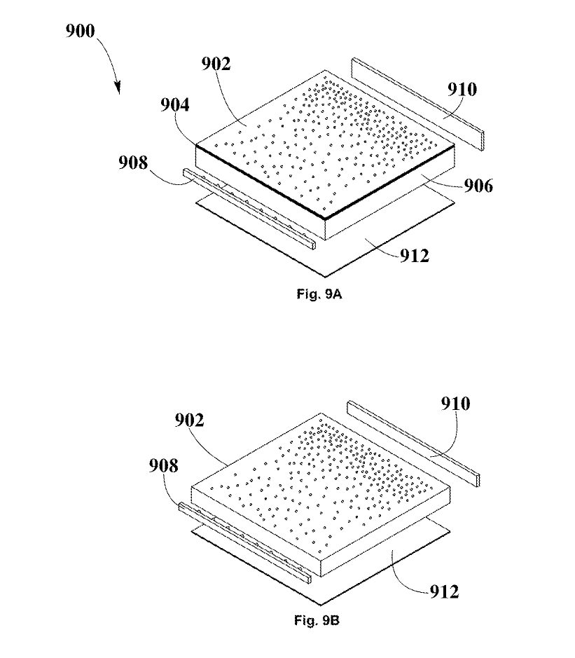

FIG. 9A shows an isometric view of a light guide 900. As shown, a substrate is printed with a pattern 902 of dots. The pattern 902 preferably includes dots of the same size that are distributed non-uniformly across the substrate. Underneath the printed substrate, an adhesive layer 904 (transparent glue) laminates the printed substrate to a light guide 906. An LED assembly 908 comprise a light source, placed at one side of waveguide 906, specifically where the dots in the pattern are less dense. Opposite to the LED assembly 908 and at the rear end of waveguide 906, an end mirror 910 is located. Finally, a specular or diffuse reflector 912 forms the bottom layer.

FIG. 9B shows a light guide with a dot pattern 902 similar to that of FIG. 9A, but the dots are printed directly on the light guide itself instead of substrate that is laminated to the light guide. Thus, in FIG. 9B no lamination is required as the printed substrate acts as the waveguide. The printed substrate may have a thickness of 0.5 to 1 mm. As explained previously, an LED assembly 908 is a light source and is located at one side of the printed substrate (waveguide), specifically where the dots in the pattern are smaller. Opposite to the LED assembly 908 and at the rear end of printed substrate (waveguide), an end mirror 910 is located. Finally, a specular or diffuse reflector 912 forms the bottom layer.

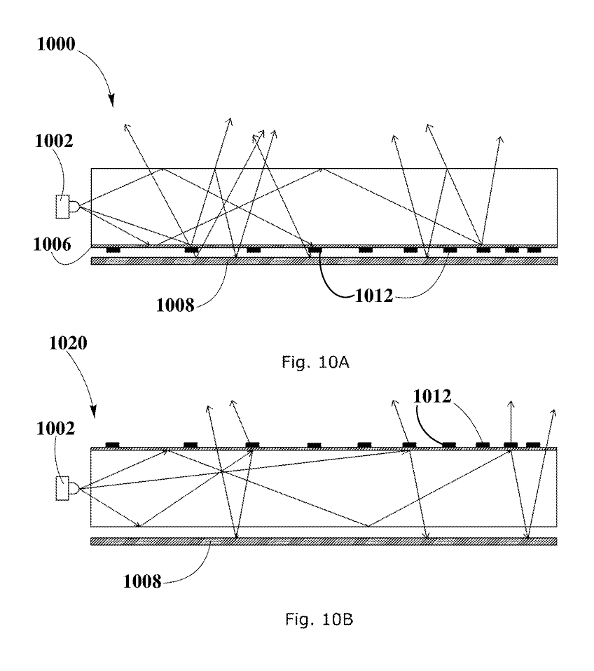

FIGS. 10A and 10 show light guides 1000 and 1020 that illustrate how any of the light guides described herein operate. A portion of the light emitted from LED assembly 1002, which may be, for example, white, red, green or blue light, is trapped by way of total internal reflection. Rays that are less than the critical angle, which is about 42 degrees respect to the normal, are captured or trapped into the light guide. The light guide 1000 in FIG. 10A includes the light extraction features 1012 (which may have been formed on a substrate 1006 laminated to the light guide or printed formed directly on the light guide itself) on the same side of the light guide as reflector 1008. In FIG. 10B, the light extraction features 1012 are on the opposing side of the light guide as the reflector 1008.

Rays that encounter a feature, depending on the angle of incidence, may split apart into various directions as shown. Some rays may pass through the features 1012 in FIG. 10A and reflect off the reflector. In FIG. 10B, some rays reflect of the features 1012, down through the light guide and further reflect off the reflector 1008 as shown. Some rays may reflect off the light features. A significant portion of the rays ultimately pass through the light guide as shown.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for making a light guide, comprising:
transferring ink onto a master tool having a three-dimensional feature pattern formed thereon;
transferring ink from the master tool to a transparent light guide; and
curing the ink on the light guide.

2. The method of claim 1 further comprising forming the master tool by engraving a predetermined pattern in a black resist material exposing a clear film creating a pattern of openings to the light transmission.

3. The method of claim 2 wherein forming the master tool further comprises applying ionizing radiation through open spacing's in the black resist material to a blank elastomeric laminated photoresist.

4. The method of claim 1 wherein the feature pattern comprises a plurality of nonuniformly-spaced, uniform-size light extraction features.

5. The method of claim 1 wherein the feature pattern comprises a plurality of uniformly-spaced, nonuniformly-sized light extraction features.

6. The method of claim 1 wherein the light guide comprises a polymer substrate light guide having a thickness of about 0.5 mm to 1 mm.

7. A light guide manufactured according to the method of claim 1.

8. A method for making a light guide, comprising:
transferring ink onto a master tool having a three-dimensional feature pattern formed thereon;
transferring ink from the master tool to a transparent substrate;
curing the ink on the substrate; and
laminating the substrate to the light guide.

9. The method of claim 8 further comprising attaching a diffuse reflector to the light guide.

10. The method of claim 8 wherein laminating the substrate comprises laminating the substrate to one side of the light guide and attaching a diffuse reflector to the substrate thereby sandwiching the substrate between the light guide and the reflector.

11. The method of claim 8 further comprising laminating the substrate to one side of the light guide and attaching a diffuse reflector an opposing side of the light guide.

12. The method of claim 8 wherein the feature pattern comprises a plurality of nonuniformly-spaced, uniform-size light extraction features.

13. The method of claim 8 wherein the feature pattern comprises a plurality of uniformly-spaced, nonuniformly-sized light extraction features.

14. The method of claim 8 wherein curing comprises subjecting the substrate to ionizing radiation.

15. The method of claim 8 further comprising forming the master tool by engraving a predetermined pattern in a black resist material exposing a clear film creating a pattern of openings to the light transmission.

16. The method of claim 15 wherein forming the master tool further comprises applying ionizing radiation through open spacing's in the black resist material to a blank elastomeric laminated photoresist.

17. A light guide manufactured according to the method of claim 8.
